(19) United States
(12) Patent Application Publication
(10) Pub. No.: US 2003/0101188 A1
(43) Pub. Date: May 29, 2003

(54) Apparatus and method for a network copying system

(76) Inventors: Ming Se Teng, Hsin Chu City (TW); Chee-Kong Chong, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/991,687

(22) Filed: Nov. 26, 2001

(51) Int. Cl. G06F 7/00

(52) U.S. Cl. 707/100

(57) ABSTRACT

A network copying system includes at least one user end, a server end, and at least one copying unit. The user end includes a network interface, at least one user end disk, and a browser. The network copying system reads data of the user end disk and transmits the data to a network through the network interface. The browser generates copying commands to the network. The server end includes the network interface and at least one server end disk. The server end disk receives the data and the copying commands from the user end and outputs the data and the copying commands to an external interface by the network interface. After copying operations, the copying unit may acknowledge users with a message.

### BACKGROUND OF THE INVENTION

1. Field of the Invention

The present invention relates to an apparatus and a method for a network copying system and, more particularly, to an apparatus and a method of a network copying system, which enables the user to copy data to a recordable disk in a remote computer through a LAN (local area network) or the Internet.

2. Description of the Prior Art

Following fast development of Internet technology, various network master-slave architectures have been disclosed for different purposes. Furthermore, when copying data from one is computer disk to another, an independent CD-writer/disk copier is needed, and, as this result, the capability of expansion is limited. At this point, there still no related inventions especially by means of network management for this copying data operation.

### SUMMARY OF THE INVENTION

It is therefore a primary objective of the present invention to provide an apparatus and a method for a network copying system, which enables the user to use a browser to monitor remote copying units and to select which data and which copying unit to be copied. Additionally, the present invention also provides users an apparatus and a method of a network copying system to copy data by just controlling their own remote computer devices through the network and to acknowledge users after the data copy operations have been finished.

In accordance with the claimed invention, a network copying system includes at least one user end, a server end, and at least one copying unit. Each user end includes a network interface, at least one user end disk, and a browser. Data stored in the user end disk are read and transmitted to a network through the network interface. The browser is to generate copying commands to the network by a network protocol, like the PPP, the HTTP, or the FTP network protocol. The server end includes the network interface and at least one server end disk. The server end disk receives the data and the copying commands from the user end and outputs them to an external interface by the network interface. The network interface is to connect the user end through the network. And, copying units are connected to the external interface to receive and store the data from the server end and copy the data after receiving the copying commands.

It is an advantage of the present invention that enables the user to copy data to a computer recordable disk in a remote copying unit through a network. By means of the network management, users are able to copy data from their own computer devices to other remote computer devices.

These and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

FIG. 1 is a schematic diagram according to the present invention.

FIG. 2 is another schematic diagram of the present invention.

FIG. 3 is a circuit block diagram of a copying unit according to the present invention.

FIG. 3A is a circuit block diagram of a chipset of the copying unit according to the present invention.

FIG. 4 is an operational flow chart of the present invention.

FIG. 5 is a schematic diagram of a user interface according to the present invention.

### DETAILED DESCRIPTION OF THE PREFERRED EMBODIMENT

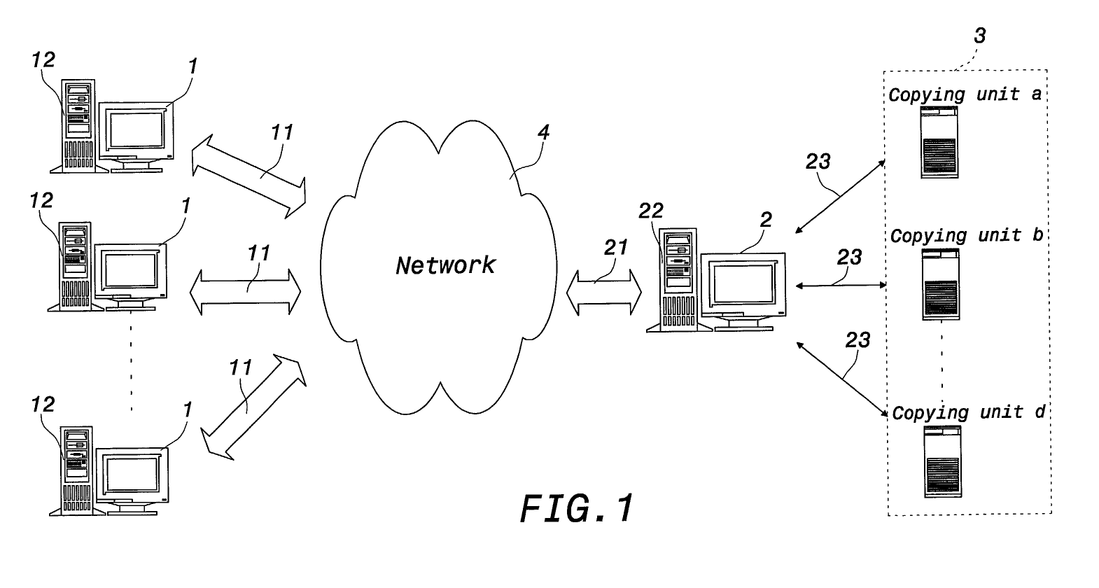

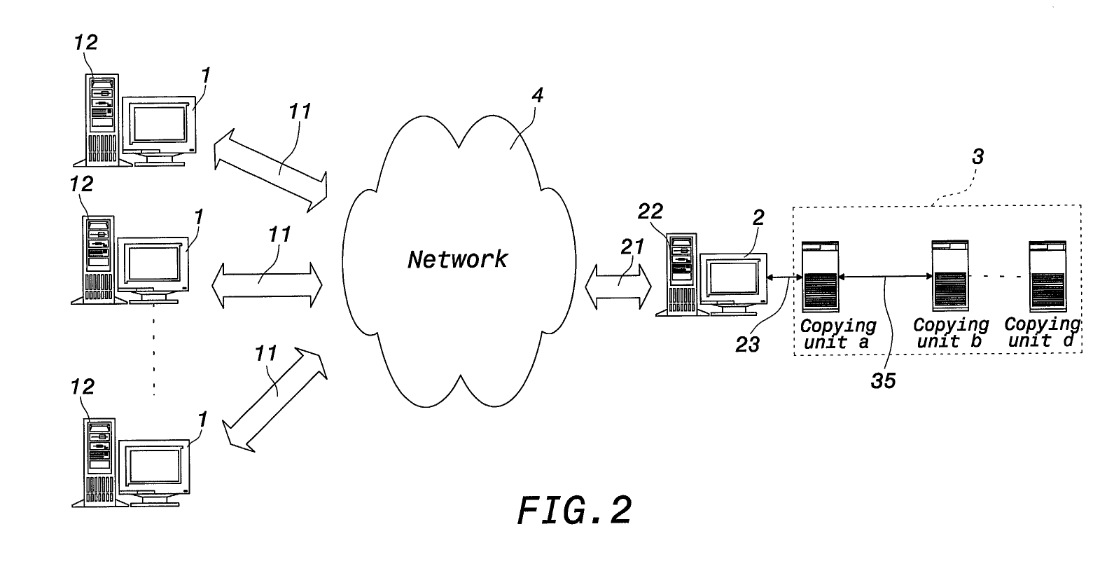

Please refer to FIG. 1 of a schematic diagram according to the present invention. As illustrated, the network copying system includes at least one user end 1, a server end 2, and at least one copying unit 3. Network interfaces 11 and 21 are used to connect the user end 1 and the server end 2 through the network 4. Each user end 1 includes a user end disk 12, and the server end 2 includes its own server end disk 22. The network copying system further includes at least one copying unit 3, which connects to the server end 2 by an external interface 23. The external interface 23 can be the wired interface, like an IEEE 1394 interface, a USB interface, an Ethernet interface, or a fiber channel interface, or the wireless interface. Several copying units 3 can be connected in a parallel or a serial manner (referring to FIG. 2). The user end 1 and the server end 2 forms a master-slave architecture through the network 4. The network interface 11 is an Ethernet interface, the user end disk 12 can be a CD-ROM or a DVD-ROM, and the network 4 can be a LAN or an Internet.

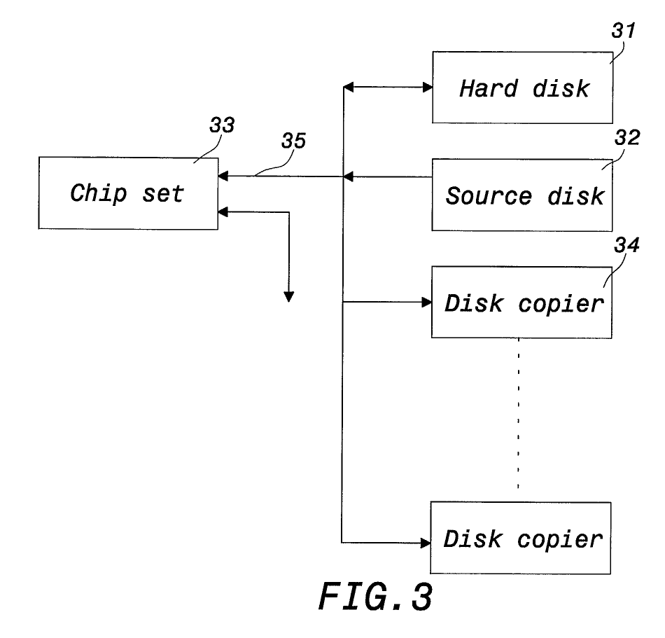

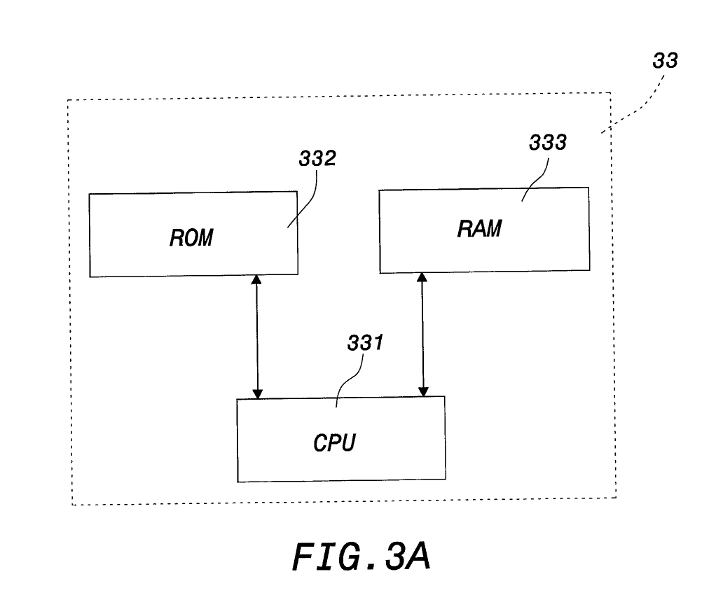

Please refer to FIG. 3 of a circuit block diagram of the copying unit. The copying unit includes a hard disk 31, a source disk 32, a chipset 33, and at least one disk copier 34. The hard disk 31, the source disk 32, the chipset 33, and the disk copier 34 are connected with each other by an internal interface 35, which can be an IDE interface, a SCSI interface, an IEEE 1394 interface, a USB interface, an Ethernet interface, or a fiber channel interface.

Please refer to FIG. 3A of a circuit block diagram of the chipset 33 in conjunction with FIG. 1 and FIG. 2. The chipset 33 includes a CPU (central processing unit) 331, a ROM (read only memory) 332, and a RAM (random access memory) 333. The chipset 33 is used to connect with the corresponding external interface 23 of the server end 2 for receiving the data and copying commands from the server end 2 and transferring received data and copying commands to the hard disk 31 of the copying unit 3 through the corresponding internal interface 35 regardless of the connection type of the copying unit 3. The disk copier 34 can be a CD-R player, a CD-RW player, a DVD-R player, a DVD+RW player, a DVD−RW player, or a DVD-RAM player, all of whom can be driven by the chipset 33 for reading the data stored in the hard disk 31 and copying the data to the disk of the disk copier 34.

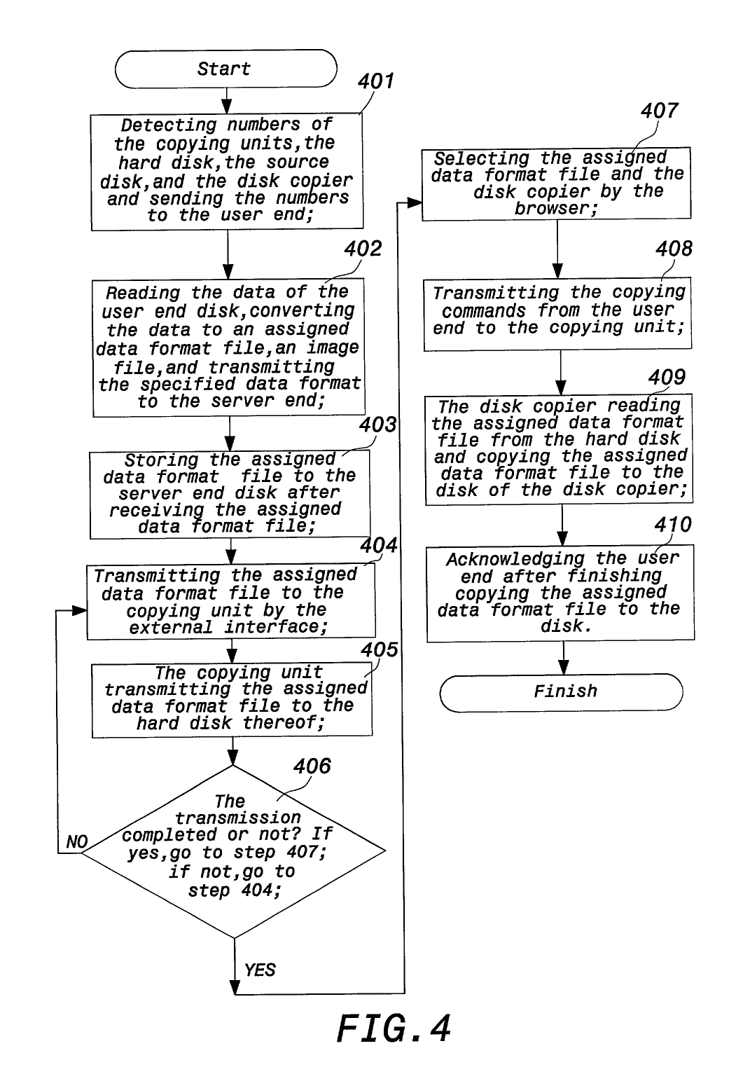

By means of the aforesaid architecture, users at the user end 1 can monitor the operation situation of the copying unit 3 through the network 4 and control the copying operation. Referring to FIG. 4 of an operation flow chart according to the present invention. It includes following steps:

step 401: detecting numbers of the copying units, the hard disk, the source disk, and the disk copier and sending the numbers to the user end;

step 402: reading the data of the user end disk, converting the data to an assigned data format file, like an image file, and transmitting the assigned data format file to the server end;

step 403: storing the assigned data format file to the server end disk after receiving the assigned data format file;

step 404: transmitting the assigned data format file to the copying unit by the external interface;

step 405: the copying unit transmitting the assigned data format file to the hard disk thereof;

step 406: the transmission completed or not? If yes, go to step 407; if not, go to step 404;

step 407: selecting the assigned data format file and the disk copier by the browser;

step 408: transmitting the copying commands from the user end to the copying unit;

step 409: the disk copier reading the assigned data format file from the hard disk and copying the assigned data format file to the disk of the disk copier;

step 410: acknowledging the user end after finishing copying the assigned data format file.

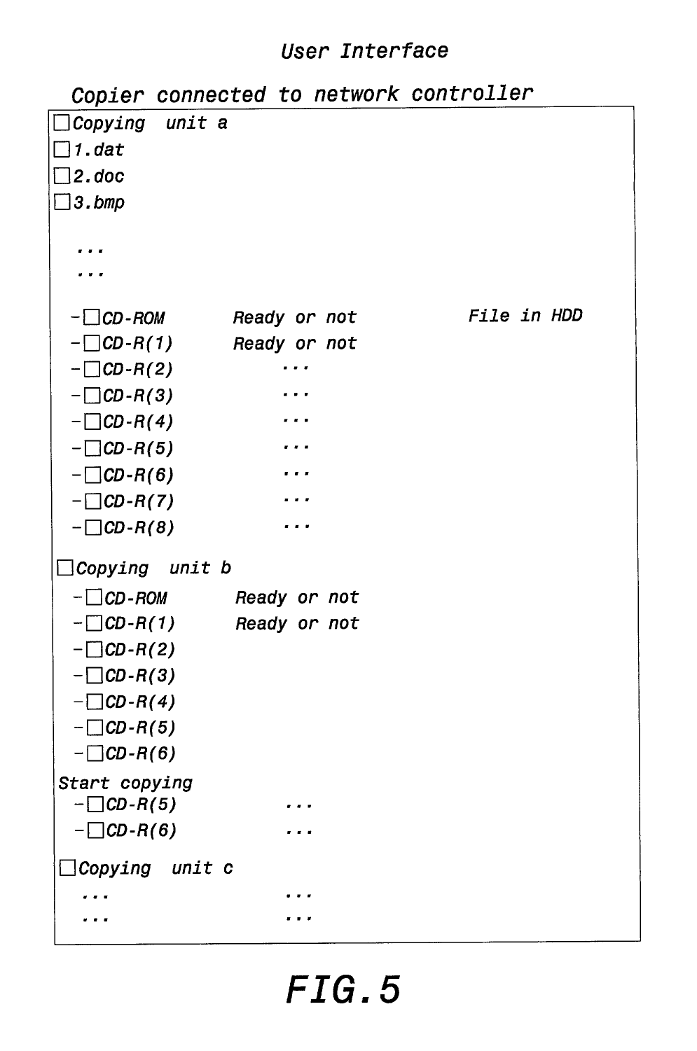

Please refer to FIG. 5 of a schematic diagram of a user interface. The user interface lets users select to operate any available disk copier by the browser. After selecting, the detailed information about the hard disk of the copying unit will be shown on the right side of the user interface. As this result, users are able to select which files and which disk copier to be executed the copying operations. Besides, the user interface is a HTML text and thus can be viewed by an ordinary browser.

In comparison with the prior arts, the present invention provides users to monitor, select at least one disk copier, and perform copying operation through the network. And, after finishing the copying operations, the network copying system will acknowledge users. By the management of the network, the capability of the expansion increases because the there is no need of additional isolated disk copiers required to be connected at the user end and so that the total number of copying units can be as large as possible because they can be controlled directly through the network.

Those skilled in the art will readily observe that numerous modifications and alterations of the device may be made while retaining the teachings of the invention. Accordingly, the above disclosure should be construed as limited by the metes and bounds of the appended claims.

What the invention claimed is:

1. A network copying system comprising:
at least one user end, each of said user end including a network interface, at least one user end disk, and a browser, said network copying system reading data of said user end disk and transmitting said data to a network through said network interface, said browser generating copying commands to said network by a network protocol;
a server end including said network interface and at least one server end disk, said server end disk receiving said data and said copying commands outputted from said user end and outputting said data and said copying commands to an external interface by said network interface, said network interface connecting said user end through said network; and
at least one copying unit connected to said external interface for receiving and storing said data from said server end and copying said data after receiving said copying commands. The network copying system as claimed in claim 1, wherein said network protocol is a PPP, a HTTP, or a FTP protocol.

2. The network copying system as claimed in claim 1, wherein said network interface is an Ethernet network interface.

3. The network copying system as claimed in claim 1, wherein said network is a LAN or an Internet.

4. The network copying system as claimed in claim 1, wherein said external interface is a wireless or a wired interface.

5. The network copying system as claimed in claim 1, wherein each of said copying unit comprises a hard disk, a source disk, a chipset, and at least one disk copier, said source disk reading disk data thereof, said chipset connecting with said external interface for receiving said data from said server end, storing said data to said hard disk, and receiving said copying commands from said server end, said disk copier driven by said chipset for reading said data of said hard disk and copying said data to a disk thereof.

6. A network copying method used in the network copying system of claim 5, comprising the steps of:
(a) detecting numbers of said copying unit, said hard disk, said source disk, and said disk copier and sending said numbers to said user end;
(b) reading said data of said user end disk, converting said data to an assigned data format file, and transmitting said assigned data format file to said server end;
(c) storing said assigned data format file to said server end disk after receiving said data format file;
(d) transmitting said assigned data format file to said copying unit by said external interface;
(e) said copying unit transmitting said data format file to said hard disk thereof;
(f) selecting said assigned data format file and said disk copier by said browser;
(g) transmitting said copying commands from said user end to said copying unit;
(h) said disk copier reading said assigned data format file from said hard disk and copying said assigned data format file to said disk of said disk copier; and
(i) acknowledging said user end after finishing copying said assigned data format file to said disk.

7. The network copying method as claimed in claim 6 wherein said chipset comprises a CPU (central processing unit), a ROM (read only memory), and a RAM (random access memory).

8. The network copying method as claimed in claim 6, wherein said assigned data format file is an image file.
